(19) United States
(12) Patent Application Publication
(10) Pub. No.: US 2008/0054660 A1
(43) Pub. Date: Mar. 6, 2008

(54) Double handle shovel

(76) Inventor: Alan Wensman, Los Alamitos, CA (US)

Correspondence Address: GREENBERG & LIEBERMAN, LLC, 2141 WISCONSIN AVE, N.W., SUITE C-2, WASHINGTON, DC, 20007, US

(21) Appl. No.: 11/011,832

(22) Filed: Dec. 14, 2004

(51) Int. Cl. A01B 1/02

(52) U.S. Cl. 294/58

(57) ABSTRACT

A double handle shovel that increases the efficiency of the tool in a manner that reduces the risk of injury to the user and increases the ease of use. The first handle is strait and the second handle is turned so that the user's body avoids unnecessary torque. The second handle is perpendicular to the head to allow for more leverage and better side to side manipulation. And the head is offset 40 degrees form the first handle to help maintain proper body alignment.

### FIELD OF INVENTION

The present invention is a double handle shovel, more specifically it is a double handle shovel to provide for more efficient digging.

### BACKGROUND OF INVENTION

Often today, when one desires to dig a hole, a machine is used such as a bull dozer, a back hoe or a construction sized drill. However efficient these machines may be, they are quite big, are used for large holes and very costly. Therefore, if one desired to dig a hole for gardening, a small pond or even a small weather trench these large machines would not be necessary. However, conventional hand shovels today because of their design, are cumbersome and inflict unnecessary stress on the users body and tend to use more energy and effort than is necessary. Additionally, conventional shovels today are often mass produced and quality is often set aside for convenience and to save money and as a result the shovels break and become unserviceable.

U.S. Pat. No. 4,050,728 issued to Davidson, Glenn E. on Sep. 27, 1977 shows a double handled shovel. Unlike the present invention Davison's invention's secondary handle has a universal joint that allows it to pivot. It is not fixedly attached to provide additional strength and support.

U.S. Pat. No. 5,133,582 issued to Rocha, Louis F. on Jul. 28, 1992 shows a two handled shovel. Unlike the present invention Rocha's invention's secondary handle rotates freely via a rotary bushing. Additionally Rocha's invention's first and secondary handle have turned handles. It is not fixedly attached to provide additional strength and support and does not have a straight primary handle to eliminate damaging torque on the user's arms.

U.S. Pat. No. 5,411,305 issued to Revoldt, Paul L. on May 2, 1995 shows a double handled shovel with the secondary handle being triangular in shape. Unlike the present invention Revoldt's invention's secondary handle pivots not providing enough strength and stability. Additionally Revodlt's invention does not offer a straight primary handle to eliminate damaging torque on the user's arms.

U.S. Pat. No. 5,704,672 issued to Sims, Alan M. on Jan. 6, 1998 shows a double handled shovel. Unlike the present invention Sims's invention's secondary handle is a resilient and/or flexible cord. It does not provide strength and stability nor does it provide better control of the invention. It does not allow the user to maintain a proper body posture to prevent injury. Additionally Sims's invention does not offer a straight primary handle to eliminate damaging torque on the user's arms.

U.S. Pat. No. 5,921,600 issued to Lucas, Michael J. on Jul. 13, 1999 shows a dual handled device. Unlike the present invention Lucas's invention's secondary handle pivots. It does not provide strength and stability. Additionally Lucas's invention does not offer a straight primary handle to eliminate damaging torque on the user's arms.

Thus there is a need for a shovel that is stronger and more durable, that provides better control and that helps maintain the proper body alignment to reduce the risk of user injury.

### SUMMARY OF INVENTION

There is a need for a shovel with two handles that does not have any pivoting joints and that has a head at an angle that improves the efficiency of the shovel.

The present invention is a double handle shovel, used for activities such as gardening that increases the efficiency of the tool in a manner that reduces the risk of injury to the user and increases the ease of use.

The present invention has two handles, and a angled head. The first handle functions much like any existing conventional shovel in conjunction with the head with the exception of the 40 degree offset. The second handle intersects with the first handle almost perpendicular to the head to provide an improved, less strenuous way to lift a load that the present invention is capable of bearing. Additionally, the first handle's grip is straight. The second handle's grip is turned, perpendicular to the first handle's grip. This concept allows the users body to stay relatively straight and eliminates damaging torque of the arms. It also allows for better side to side manipulation of the head by simply moving the second handle side to side. This is useful for example, when loosening dirt as the user is digging or wedging the head further into a gravel pile to lift more. The head of the present invention is angled in such a way that as the user is holding the second handle, the head will be horizontal so as to not let the load that the present invention is bearing fall out. Additionally angling the head as well as the second handle helps maintain proper body alignment while using the present invention. Each piece of the present invention; the first handle, second handle and the head are all welded together to provide more strength and durability.

### BRIEF DESCRIPTION OF DRAWINGS

FIG. 1 is a side view of the present invention.

FIG. 2 is a side view of the present invention in use.

FIG. 3 is an environmental view of the present invention in use.

FIG. 4 is a side view of the present invention showing the relationship of the two handles length.

### DETAILED DESCRIPTION

The present invention is a shovel with two handles. The first handle is primarily used to break into the surface of the material and the second handle is used to lift the load of material.

The present invention has two main goals. First, the present invention aims to reduce the amount of strenuous force, projected by the user, normally needed in a conventional shovel by adding a second handle and angling the head; and second, the present invention aims to increase efficiency with less effort.

As shown in FIG. 1, first handle (10) is the primary handle and is a long tubular shaft that directly connects, via welds, with the head (30). The 40 degree bend (15) in the first handle (10), located approximately 4 to 5 inches above the head (30), is to create an offset that will allow for increased digging efficiency. Upper section (13), of first handle (10), is located above the 40-degree bend (15) and is the main section of first handle (10). Lower section (17), of first handle (10), is located below the 40-degree bend (15) and is perpendicular to the head (30). Attached to lower section (17), via welds, is second handle (20). Second handle (20) is triangle in shape, with the base of the triangle being the hand grip (25) and is made of a single metal tube bent to form the triangle. Second handle (20) is directly in line with lower section (17) and in turn also perpendicular to head (30). The head (30) can be any shape suitable for digging, however the preferred embodiment is the conventional flat edged shape, allowing for maximum penetration and maximum load capacity (sensible to a hand held shovel).

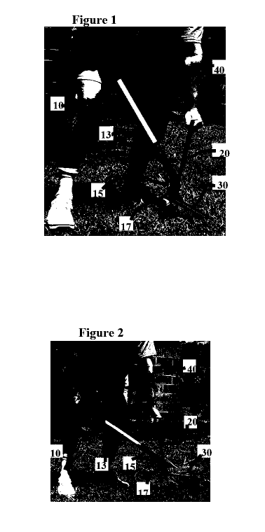

FIG. 2 shows the present invention in use. As shown, when second handle (20) is held naturally perpendicular to the ground head (30) is parallel to the ground allowing head (30) to bear its load evenly minimizing the amount of material dropped while the user (40) is lifting the present invention. This is made possible by the offset attribute of first handle (10) via 40 degree bend (15). Note: First handle (10) is still held by the user (40) to stabilize the present invention.

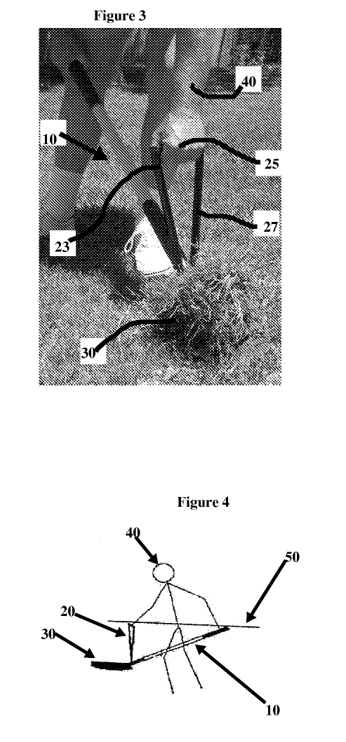

FIG. 3 shows second handle (20) in better detail. As shown second handle (20) has three sections; first section (13) is the longer left section providing adequate distance from the head (30) and the second section of second handle (20), hand grip (25). Third section (27) of second handle (20) is equal to first section (23) in length and purpose. First section (23) and third section (27) are approximately 1 to 1.5 feet long to provide adequate distance between the hand grip (25) and the head (30) allowing for enough leverage to operate the present invention with the least amount of effort.

As shown in FIG. 4 the preferred length of second handle (20) is directly related to the length of first handle (10). If a level horizontal line (50) is drawn from the top part of first handle (10) it will line up with the top of second handle (20). Therefore, regardless of the length of first handle (10) the length of second handle (20) will correlate respectively.

In an alternate embodiment the present invention has a larger, spade shaped head (30). Additionally the lower section (17) of first handle (10) connects with head (30) at a 40 degree angle to create the offset.

I claim:

1. A double handle shovel, comprising:
a first handle;
a second handle in communication with said first handle; and
a head in communication with said first handle and said second handle;
wherein said first handle is angled 40 degrees where it is in communication with said head.

2. The device of claim 1, wherein said second handle is attached perpendicular to said head.

3. The device of claim 1, wherein said first handle is welded to said head.

4. The device of claim 1, wherein said second handle is welded to said first handle.

5. The device of claim 1, wherein said second handle is welded to said head.

6. The device of claim 2, wherein said first handle offsets said head.
